(19) United States
(12) Patent Application Publication
(10) Pub. No.: US 2015/0251478 A1
(43) Pub. Date: Sep. 10, 2015

(54) ENHANCED ORGANIZER NOTEBOOK

(71) Applicant: CARVAJAL, S.A. DE C.V., Distrito Federal (MX)

(72) Inventor: Gloria MONTIEL CUAMATZI, Distrito Federal (MX)

(73) Assignee: CARVAJAL, S.A. DE C.V., Distrito Federal (MX)

(21) Appl. No.: 14/717,269

(22) Filed: May 20, 2015

Related U.S. Application Data
(62) Division of application No. 13/902,252, filed on May 24, 2013.

(30) Foreign Application Priority Data
May 24, 2012 (MX) MX/A/2012/005999

(51) Int. Cl. B42D 3/00; B42D 3/12; B42D 1/10; B42D 1/04; B42D 1/06

(52) U.S. Cl. CPC B42D 3/006; B42D 1/04; B42D 1/06; B42D 1/10; B42D 3/12

(57) ABSTRACT

A notebook includes a top cover, a bottom cover, a spine that bonds both covers and that has a bonding means, and sheets bonded by said bonding means. The notebook has three borders comprised by the edge or thickness of each of the sheets. The notebook has a first base bonded to the sheets, wherein a cover is bonded by three of its sides to the first side, thus leaving an unbonded side. The notebook has a second base bonded to the sheets, which has a tabs zone housing at least one tab. The notebook may include a coating resulting from a dye spraying procedure over the borders. The dye has a desired viscosity that when it contacts the border, only an amount of dye that covers the edge or thickness of each sheet is absorbed, thus preventing the dye from smearing towards the inner part of the sheet.

### CROSS-REFERENCE TO RELATED APPLICATIONS

This application is a Divisional of Application No. 13/902,252 filed May 24, 2013, and claims priority under 35 U.S.C. §119 from patent application number MX/a/2012/005999 which was filed on May 24, 2012, in the Mexican Patent Office, and which is hereby incorporated by reference in its entirety.

### TECHNICAL FIELD

Illustrative embodiments relate to the field of notebooks and notepads. Particularly, an illustrative embodiment comprises a plurality of improvements to notebooks, booklets or similar products, such as identification and organization features incorporated therein.

### BACKGROUND

A wide plurality of notebooks, booklets and/or similar products which are used for taking notes in several fields is currently known. These products are particularly used in the educational field, wherein the users may attend more than one class or subject matter, to which a notebook per subject matter is usually assigned. In this case, users may have trouble identifying the notebooks or booklets whose outward appearances are identical or similar. For example, if two or more notebooks are kept within a backpack, the user may not easily identify from his standpoint, to which subject matter each respective notebook corresponds. Another example is that, if the notebooks are disposed on any shelf furniture, in a similar way, the identification of the subject matter to which each respective notebook corresponds may not be easy. In some cases, the users are obliged to cover notebooks with some material of a distinctive or identifying color. In this regard, it is very common that the materials for covering notebooks are not sufficiently hardwearing during the class or subject matter cycle.

There are some related art patent documents addressed to providing a solution for identifiable notebooks and booklets. For instance, the utility model BG98066 from Bulgaria, proposes a booklet comprising a plurality of sheets located between two covers, a top cover and a bottom cover. In the available information about utility model BG98066, it is stated that the plurality of sheets may be divided by tabs in subsets of sheets, wherein each subset of sheets may be a different color. A drawback of utility model BG98066 is that the division into subsets of colors in a same booklet does not solve the identification troubles among several booklets. Likewise, the manufacturing procedure of said color sheets is not mentioned.

On the other hand, U.S. Patent Publication No. 2010/187801 describes an organization system for calligraphy notebooks. This system consists of a set of notebooks comprising color covers for identifying each notebook with one subject matter. U.S. 2010/187801 proposes up to 8 different colors. The main drawback of this notebook system is that the color of the borders is not mentioned, so this system may not be easily identifiable from a top, front or bottom perspective of the set of notebooks. Furthermore, U.S. 2010/187801 is silent with respect to the manufacturing of said organization system for notebooks.

Further, an illustrative embodiment also embodies features for solving the organization problem by the user of the notebook. It is very common that the user of the notebook has to divide sections within the notebook. It is also common that the user of the notebook has the need for keeping loose documents related to the notebook. Finally, it is likely common that the user of the notebook has to organize the contents of the notebook by means of a sheet lining that is different from the conventional one.

Thus, there are some related art patent documents addressed to providing solutions to the troubles regarding organization of notebooks. For example, Japanese Patent No. JP05095028 describes a booklet with a plurality of sheets bonded at one of its sides. Each of the sheets has different tabs that are selected and bent outwardly in order to classify the sheets. JP05095028 has a drawback that the tabs are opened being bonded by one side to the sheet and not by glue. Additionally, the tabs must be swaged in each sheet, which involves higher manufacturing costs of the notebook.

On the other hand, U.S. Pat. No. 8,196,964, describes a sticky notepad with a tab portion and the rest of the body with spaces and lines for writing, arranged for being partially removable, wherein the portion that is not removed forms an aggregate of non-removable portions wherein a pen or like stationery device may be located. U.S. Pat. No. 8,196,964 has a drawback in that the tabs are not included in the notebook or application book, but they comprise an independent block. Furthermore, the additional features that U.S. Pat. No. 8,196,964 includes are not related to the previously cited organization troubles.

Likewise, U.S. Patent Publication No. 2012/0098246 discloses in one of its embodiments, an adhesive tab holder. Said holder is armed with hook projections coupled to the spine of the common notebooks. Likewise, U.S. Patent Publication No. 2012/0091015 discloses an adhesive tab holder similar to U.S. 2012/0098246, armed with hook projections coupled to the spine of the common notebooks. The first embodiment of U.S. 2012/0091015 describes a long hook projection and a slip-on short hook projection. While in the second embodiment of U.S. 2012/0091015, the holder includes the appropriate notches of the rings of a binder. All these cases have a drawback that the adhesive tab holder is adapted for interacting with a spiral notebook or a ring binder, keeping other notebook arrangements out.

Furthermore, U.S. Patent Publication No. 2011/0095516 discloses an organization system that includes a planner sheet with schedule sheets with the subject matters of the day, and the subject matters point out at a section wherein the homework is noted. In an embodiment, the booklet includes colored adhesive tabs per subject matter. A drawback of U.S. 2011/0095516 is the fact that the planner sheet has a homework organization purpose different from the purpose that an illustrative embodiment seeks to address.

Likewise, U.S. Pat. No. 7,128,957 describes a pad made from sheets comprising a plurality of adhesive tabs. An illustrative embodiment envisions the provision of one of these sheets over an application surface, as may be the back cover of a notebook. A drawback of U.S. Pat. No. 7,128,957 is the fact that the user must try to place the sheets of adhesive tabs at the indicated place, and must avoid said sheet being separated from the selected surface and/or adhering to another surface.

On the other hand, U.S. Pat. No. 6,254,955 describes a notepad including a plurality of writing sheets that are bonded in order to form a stack, wherein a plastic sheet comprises adhesive tabs for indexing the notepad. A drawback in U.S. Pat. No. 6,254,955 is the provision of the plastic sheet with adhesive tabs in the notepad.

Finally, international patent publication WO1995032097 describes a sheet full of a plurality of adhesive tabs whose principal objective is the provision of the tabs at the edge of and inside a printed material. A drawback of WO1995032097 is that the sheet is addressed for efficiently pointing out printed contents, and not for being included as a support for a user of a blank notebook.

Based on the above, there remains a need in the art for a notebook wherein all its covers and borders may be manufactured bearing a same color, thus being identifiable among notebooks of different subject matters, notwithstanding the visual angle of the user. Furthermore, in this proposed notebook, there is the need for solving the technical problem of when applying the die to the uncovered borders of the set of sheets comprised by the notebook, said die should not be absorbed by the remainder of the sheet, but only absorbed at the edge or thickness of each sheet of said not bounded uncovered borders. Likewise, there is the need in the art for facilitating the organization of the user of the notebook, when performing divisions of sections within the notebook, when keeping related loose documents and when organizing the contents of the notebook by means of a sheet lining that is different from the conventional one.

### SUMMARY

An aspect of an illustrative embodiment consists in providing a notebook wherein all its covers and borders may be manufactured bearing a same color, so as to be identifiable among notebooks of different subject matters, notwithstanding the visual angle of the user.

Another aspect of an illustrative embodiment relates to said notebook bearing only the dye of the edge or thickness of the sheets of the uncovered borders of said notebook, without the dye draining towards the inner part or the remaining paper.

Another aspect of an illustrative embodiment addresses the easiness of the organization of the user of the notebook when performing divisions of sections within the notebook.

Other aspect of an illustrative embodiment attends the need for keeping related loose documents.

Finally, an aspect of an illustrative embodiment relates to organizing the contents written in the notebook.

### BRIEF DESCRIPTION OF THE DRAWINGS

Reference will now be made in detail to illustrative embodiments with reference to the accompanying drawings, in which:

FIG. 1 shows a notebook according to an illustrative embodiment in a closed position.

FIG. 2 shows a notebook according to an illustrative embodiment in an open position at a first section.

FIG. 3A shows a notebook according to an illustrative embodiment in an open position at a second section.

FIG. 3B shows a notebook according to an illustrative embodiment in an open position at a second section during its use.

### DETAILED DESCRIPTION

The above and/or other aspects will become more apparent by describing certain illustrative embodiments with reference to the accompanying drawings.

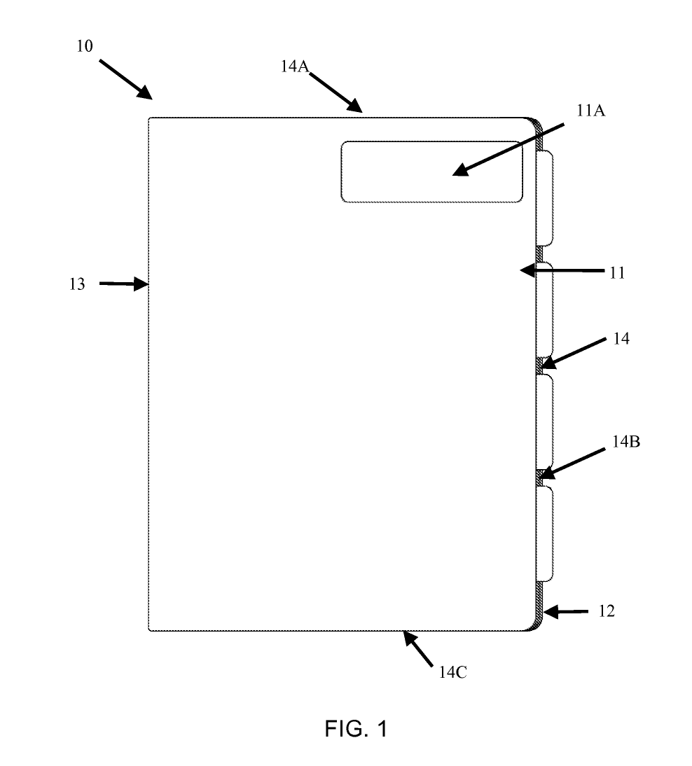

Referring to FIG. 1, an illustrative embodiment comprises a notebook (10) comprising a top cover (11), a bottom cover (12), a spine (13) that bonds both covers and that has a bonding means, and a plurality of sheets (14) bonded by said bonding means. Further, the notebook (10) is comprised by three borders (14A, 14B, 14C) comprised by the edge or thickness of each of the plurality of sheets (14). In an illustrative embodiment, the covers (11, 12) and the spine (13) are made from a material that allows showing or bearing a same color. In one illustrative embodiment, the bonding means may be glue, a spiral, rings, thread, or the like, but the present invention is not limited thereto.

The notebook (10) of this illustrative embodiment further includes a coating resulting from a dye spraying method over each of the uncovered borders (14A, 14B, 14C). The coating consists of a dye comprised by a pigment or coloring, carrier and additives that, as a whole, form a dye whose viscosity is in the range of between 14 to 20 seconds in Zahn cup # 2 EZ. According to one illustrative embodiment, the viscosity of the dye is of 17 seconds in Zahn cup # 2 EZ. Likewise, the dye may have a pH of 8.3 to 8.7. According to one illustrative embodiment, the pH of the dye is 8.5. The features of the dye herein defined allows that when the dye contacts the border (14A, 14B, 14C) of the notebook (10), only an amount of dye that covers the edge or thickness of each of the sheets (14) is absorbed, thus preventing the dye from smearing towards the inner part of the sheet (14).

Furthermore, the above-described dye may be modified in the ranges defined as necessary in view of environmental conditions or paper type of the sheet of the notebooks. The viscosity of the dye may be reduced by adding 5% of water. Likewise, the drying rate of the dye may be quickened by adding up to 5% of ethyl or isopropyl alcohol under stirring. Likewise, the drying rate of the dye may be delayed by adding up to 5% of solvent.

The spraying may be created by means of a pneumatic dyeing system that fires dye towards the three borders (14A, 14B, 14C) of each notebook (10). According to one illustrative embodiment, the dyeing system may comprise a paint spray gun or an airbrush coupled to the industrial pneumatic lines, both of which are well known in the art. In one illustrative embodiment, the color of the dye corresponds to the same color of manufacture of the covers (11, 12) and of the spine (13) of the notebooks (10).

Furthermore, in one illustrative embodiment, the top cover (11) has an identification zone (11A) for manually providing written information that serves for the identification of the notebook (10).

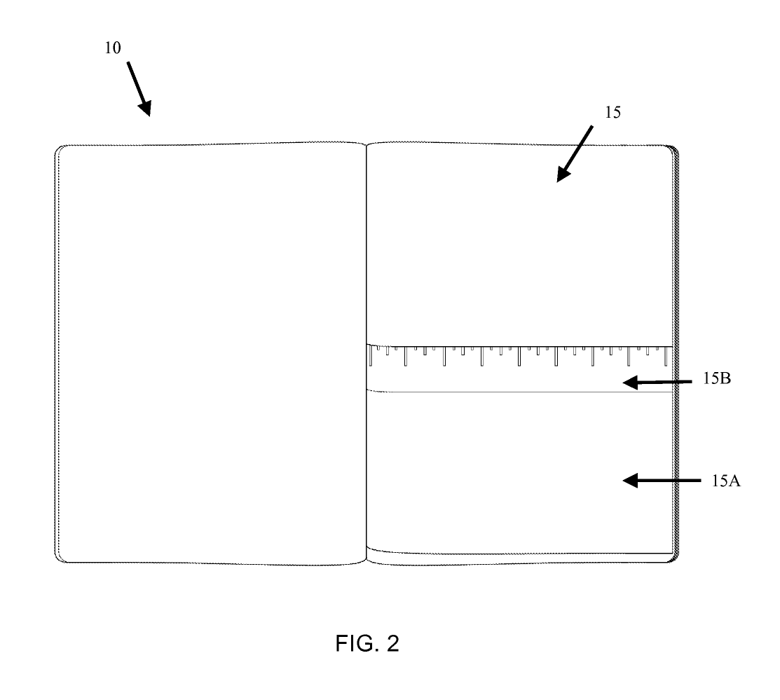

FIG. 2 illustrates an illustrative embodiment of the notebook (10) in an open position at a section including a first base (15) bonded to the plurality of sheets (14) by means of the same bonding means that bonds the sheets together. In one illustrative embodiment, the first base (15) has the same dimensions as those of the plurality of sheets (14). Furthermore, the cover (15A) has a ruler (15B) painted over the edge of the unbonded side.

During its operation, the user may place a document or sheet of the same notebook in the space between the first base (15) and the cover (15A) for its storage. Likewise, the user may perform measurements of distances when placing the document to be measured within the space between the first base (15) and the cover (15A), for visually comparing the distance with the ruler (15B) painted over the edge of the unbonded side of the cover (15A).

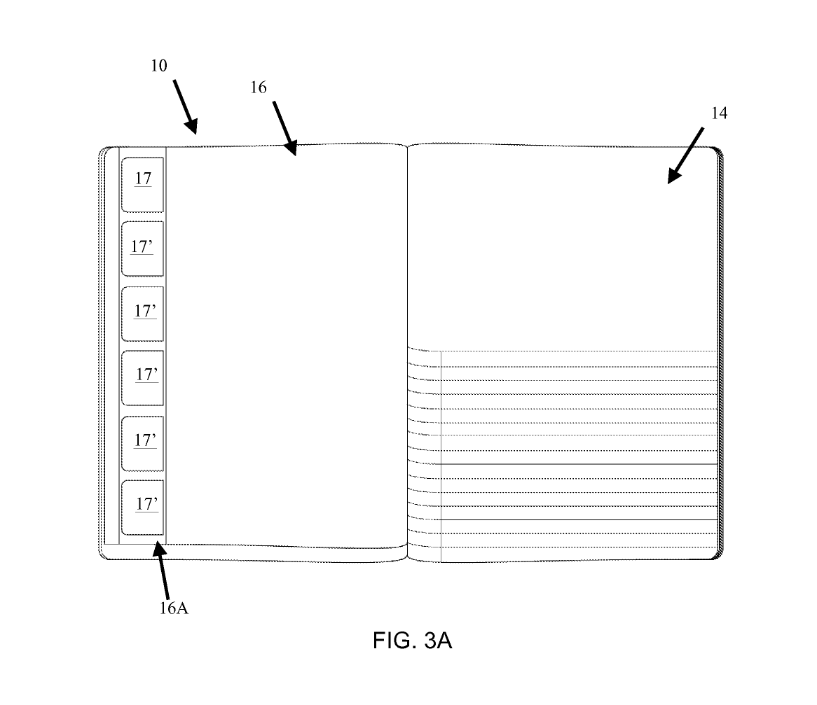

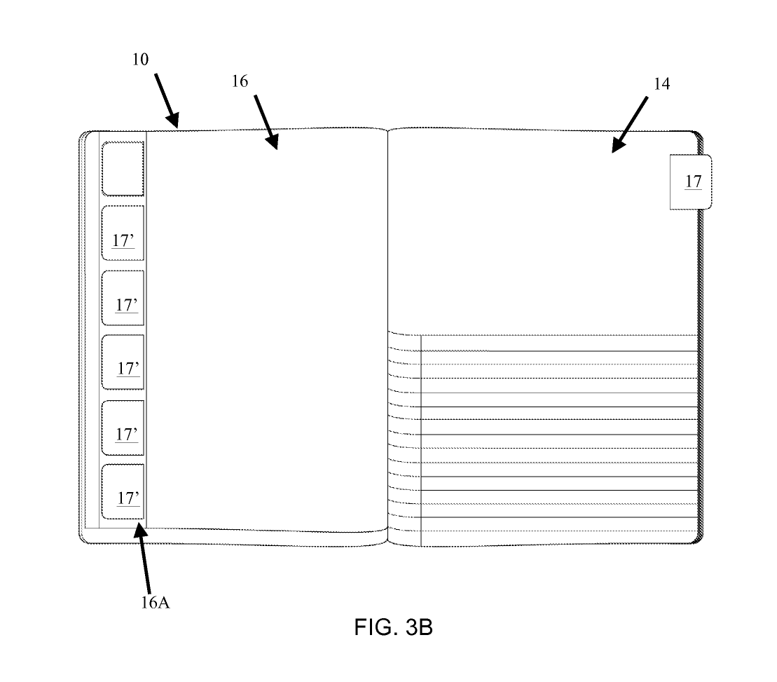

In FIG. 3A, one may observe the notebook (10) in an open position at a section that includes a second base (16) bonded to the plurality of sheets (14) by means of the same bonding means that bonds the sheets together. In one illustrative embodiment, the second base (16) has the same dimensions as those of the plurality of sheets (14). The second base (16) has a tabs zone (16A) that houses at least one tab (17). In the embodiment shown in FIG. 3A, there are six tabs (17, 17′).

During its operation, the user may unstick a tab (17) from the tabs zone (16A) in order to place it in any part of the edge of any sheet (14) of the plurality of sheets of the notebook (10), as illustrated in FIG. 3B. In this way, the user may organize blocks of sheets for pointing out indexed sections by means of at least one tab (17).

Likewise, the plurality of sheets (14) of the notebook (10) may include one or more designs of lined or grid, or even blank sheets. In the embodiment shown, the sheets (14) may have a novel design that includes an upper blank zone and a lower lined zone, as shown in FIGS. 3A and 3B. This design of sheets allows the user to place or stick an image of the subject in the upper blank zone and to write in the lower lined zone.

Finally, the first base (15) and the second base (16) may be provided in any part of the notebook (10). Furthermore, the notebook (10) may have useful information printed on any of the fronts of the bases (15, 16).

Based on the above disclosure, certain illustrative embodiments and details have been described in order to illustrate the present invention, and it will be evident to those skilled in the art that numerous variations and modifications may be made to the illustrative embodiments without departing from the spirit and scope of the embodiments of the present invention as defined in the following claims.

1. A notebook comprising:
a top cover;
a bottom cover;
a spine that bonds the top cover and the bottom cover,
wherein the spine has a bonding means; and
a plurality of sheets bonded by said bonding means,
wherein the notebook has three borders corresponding to a periphery of the plurality of sheets,
wherein the notebook further comprises:
a first base bonded to the plurality of sheets,
wherein a storage cover is bonded by three of its sides to the first base, thus leaving an unbonded side; and
a second base bonded to the plurality of sheets,
wherein the second base has a tabs zone that houses at least one tab.

2. The notebook according to claim 1, wherein the top cover has an identification zone for providing manually written information.

3. The notebook according to claim 1, wherein the first base and the second base have same dimensions as the plurality of sheets.

4. The notebook according to claim 1, wherein the storage cover is of a smaller size than the first base and has a ruler painted on an edge of the unbonded side.

5. The notebook according to claim 1, wherein the plurality of sheets comprises one or more designs from among a lined design, a grid design, and a blank design.

6. The notebook according to claim 1, wherein the plurality of sheets comprises a design that comprises a blank upper zone and a lined lower zone.

7. The notebook according to claim 1, wherein the first base and the second base are configured to be provided in any part of the notebook, and
wherein at least one of the first base and the second base has preprinted information on a front thereof.

8. The notebook according to claim 1, wherein the top cover, the bottom cover and the spine are made of a material that allows exhibiting a same color.

9. The notebook according to claim 1, wherein the bonding means comprises at least one of glue, a spiral, rings, and thread.
